(19) United States
(12) Patent Application Publication
(10) Pub. No.: US 2012/0244920 A1
(43) Pub. Date: Sep. 27, 2012

(54) Protection case for smart phone

(76) Inventor: Yuen Yee Lee, Hong Kong (CN)

(21) Appl. No.: 13/427,906

(22) Filed: Mar. 23, 2012

(30) Foreign Application Priority Data
Mar. 23, 2011 (HK) 11102966.3

(51) Int. Cl. H04W 88/02

(52) U.S. Cl. 455/575.8

(57) ABSTRACT

A protection case for a smart phone includes a foldable cover, and a protection shell that could be connected to the cover in different ways. The protection shell includes a curve-shaped base plate that could perfectly fit the back of the smart phone, and four hooks that are respectively located at the corners of the base plate. This protection case is easy to use and can prevent smart phones from damage.

### BACKGROUND OF THE PRESENT INVENTION

1. Field of Invention

This invention relates to a protection case for a smart phone, and more especially, to a protection case used to pack and protect iPhone 4 products.

2. Description of Related Arts

At present, the iPhone smart phone produced by Apple Inc. has become popular all over the world and a symbol of “fashion”. Since the product is tablet style, it is inconvenient to use and carry about without other auxiliary equipments. Therefore, some packing devices for the smart phone are available in the market for carrying a smart phone. However, these devices fail to provide a support for smart phones and are inconvenient to use.

### SUMMARY OF THE PRESENT INVENTION

An object of the present invention is to provide a protection case for a smart phone capable of containing a smart phone and being used as a smart phone support, thus achieving convenient utilization and prevention of the smart phone from accidental damage.

Accordingly, in order to accomplish the above object, the present invention provides a protection case for a smart phone, comprising a foldable cover, and a protection shell connected to the cover. The protection shell includes a curve-shaped base plate fitted a back of the smart phone, and four hooks that are respectively located at four corners of the base plate.

Preferably, two baffles are configured on two side edges of the protection shell, one of the two baffles is connected and integrated with two hooks located at two corresponding corners, and the other, which is provided with a notch, is connected and integrated with a hook located at a corresponding corner.

Preferably, an elliptic magic tape, for connecting to an internal surface of the foldable cover, is configured on a back of the base plate of the protection shell.

Preferably, a strip-shaped magic tape, for connecting to an internal surface of foldable cover when using the smart phone, is configured on an external surface of one of the two baffles of the protection shell.

Preferably, a strip-shaped magic tape, for connecting to an internal surface of the foldable cover when using the smart phone, is configured under a back of the base plate of the protection shell.

Preferably, an external surface of the foldable cover is made of leather materials and an internal surface thereof is made of flexible materials such as flannelette.

The favorable effects of the present invention are as follows: within this structure, two curve-shaped baffles are configured on two side edges of the protection shell and four hooks are respectively configured at four corners, then the iPhone/smart phone can be fastened tightly in the protection shell to prevent it from falling; afterwards, the protection shell and smart phone are put in the protection case for the convenience of carrying. When using the smart phone, lay the protection shell in the protection case together with the smart phone and adjust the angle, then fix it on the protection case. Since the angle can be adjusted arbitrarily, it is easy to use.

These and other objectives, features, and advantages of the present invention will become apparent from the following detailed description, the accompanying drawings, and the appended claims.

### BRIEF DESCRIPTION OF THE DRAWINGS

FIG. 1 is a stereogram of a protection shell of the present invention.

FIG. 2 is a back view of the protection shell of the present invention.

FIG. 3 is a developed schematic diagram of the embodiment of the invention.

FIG. 4 is a perspective view of a protection case for smart phone according to a first preferred embodiment of the present invention.

FIG. 5 is a perspective view of a protection case for smart phone according to a second preferred embodiment of the present invention.

FIG. 6 is a perspective view of a protection case for smart phone according to a third preferred embodiment of the present invention.

### DETAILED DESCRIPTION OF THE PREFERRED EMBODIMENT

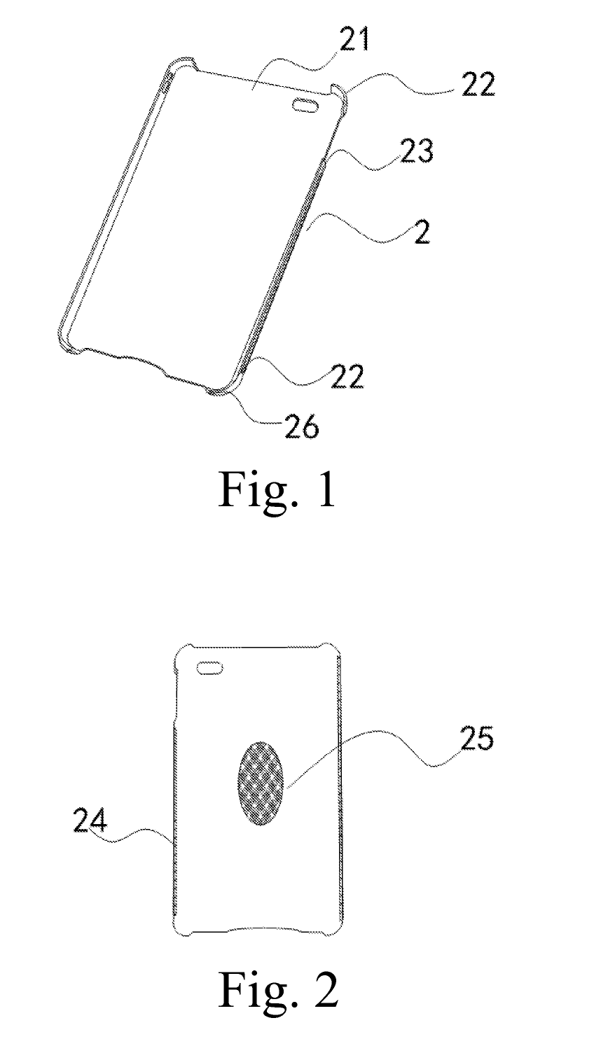

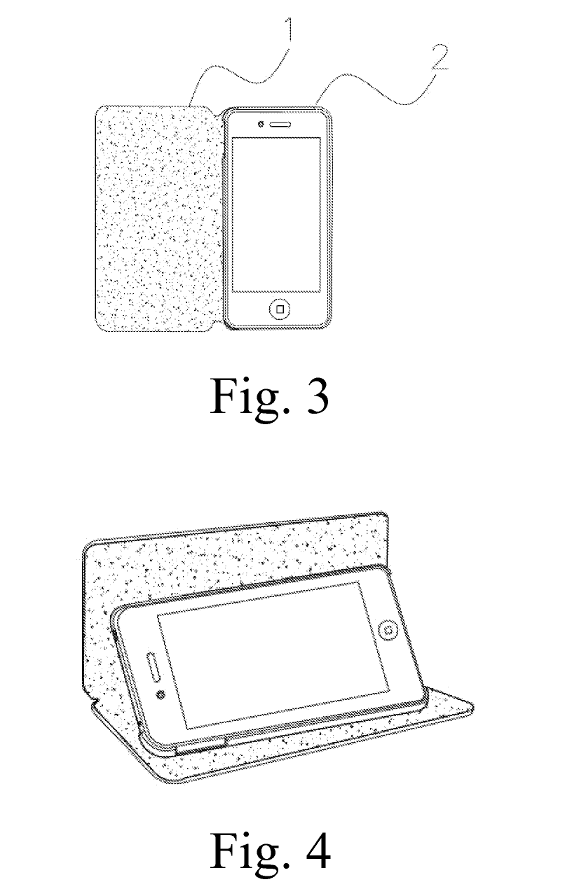

As shown in FIGS. 1-3, a protection case for a smart phone is provided by the present invention, comprising a foldable cover 1, and a protection shell 2 that could be connected to the cover 1 in different ways. The protection shell 2 comprises a curve-shaped base plate 21 that could perfectly fit the back of the smart phone, and four hooks 22 that are respectively located at four corners of the base plate 21.

Two curve-shaped baffles 23 opposite to each other are respectively configured on two side edges of the base plate 21, one of the two baffles 23 is connected and integrated with two hooks 22 respectively located at two corresponding corners, and the other baffle 23, which is provided with a notch, is connected and integrated with a hook 22 located at a corresponding corner.

FIG. 4 shows the first embodiment of the invention, wherein an iPhone 4 is put in the wide-open cover 1 together with the protection shell 2 and connects with the corresponding internal surface of the cover 1 through the strip-shaped magic tape 24 configured on the back of the baffle 23 for the convenient operation of the iPhone 4.

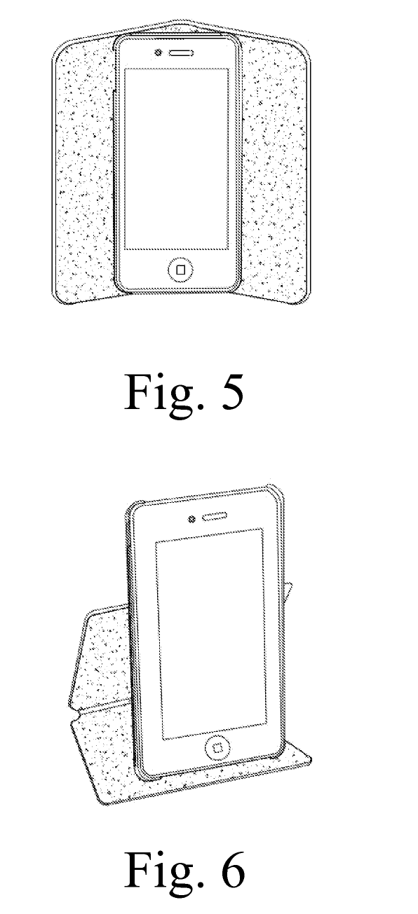

FIG. 5 shows the second embodiment of the invention, the iPhone 4 is put in the wide-open cover 1 together with the protection shell 2 and connects with the flannelette at the corresponding internal surface of the cover 1 through the strip-shaped magic tape 24 configured on the back of the baffle 23, the arrangement angle is different from the angle mentioned above to adapt different operation habits for the convenient operation of iphone 4.

FIG. 6 shows the third embodiment of the invention, wherein an iPhone 4 is put in the wide-open cover 1 together with the protection shell 2 and connects with the flannelette at the corresponding internal surface of the cover 1 through the elliptic magic tape 25 configured on the back of the protection shell 2 and the strip-shaped magic tape 26 under the back of the base plate of the protection shell, the arrangement angle is different from the angle mentioned above to adapt different operation habits for the convenient operation of iphone 4.

The above introduces the application method of the invention with an iPhone 4 as an example. But obviously, the invention can also be used for other brands of smart phones such as HTC, Motorola and other smart phones with large screens.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A protection case for a smart phone, comprising a foldable cover and a protection shell connected to the cover, wherein the protection shell comprises a curve-shaped base plate fitted a back of the smart phone, and four hooks respectively located at four corners of the base plate.

2. The protection case, as recited in claim 1, wherein a first and second baffles opposite to each other are respectively configured on two side edges of the protection shell, the first baffle is connected and integrated with the two hooks respectively located at two corresponding corners and the second baffle, which is provided with a notch, is connected and integrated with a hook located at a corresponding corner.

3. The protection case, as recited in claim 1, wherein an elliptic magic tape, for connecting to an internal surface of the foldable cover, is configured on a back of the base plate of the protection shell.

4. The protection case, as recited in claim 2, wherein an elliptic magic tape, for connecting to an internal surface of the foldable cover, is configured on a back of the base plate of the protection shell.

5. The protection case, as recited in claim 2, wherein a first strip-shaped magic tape, for connecting to an internal surface of the foldable cover when using the smart phone, are configured on an external surface of one of the first and second baffles of the protection shell.

6. The protection case, as recited in claim 4, wherein a first strip-shaped magic tape, for connecting to the internal surface of the foldable cover when using the smart phone, are configured on an external surface of one of the first and second baffles of the protection shell.

7. The protection case, as recited in claim 2, wherein a second strip-shaped magic tape, for connecting to an internal surface of the foldable cover when using the smart phone, is configured under a back of the base plate of the protection shell.

8. The protection case, as recited in claim 4, wherein a second strip-shaped magic tape, for connecting to the internal surface of the foldable cover when using the smart phone, is configured under a back of the base plate of the protection shell.

9. The protection case, as recited in claim 5, wherein a second strip-shaped magic tape, for connecting to the internal surface of the foldable cover when using the smart phone, is configured under a back of the base plate of the protection shell.

10. The protection case, as recited in claim 6, wherein a second strip-shaped magic tape, for connecting to the internal surface of the foldable cover when using the smart phone, is configured under a back of the base plate of the protection shell.

11. The protection case, as recited in claim 1, wherein an external surface of the foldable cover is made of leather materials and an internal surface thereof is made of flexible materials.

12. The protection case, as recited in claim 2, wherein an external surface of the foldable cover is made of leather materials and an internal surface thereof is made of flexible materials.

13. The protection case, as recited in claim 3, wherein an external surface of the foldable cover is made of leather materials and an internal surface thereof is made of flexible materials.

14. The protection case, as recited in claim 4, wherein an external surface of the foldable cover is made of leather materials and the internal surface thereof is made of flexible materials.

15. The protection case, as recited in claim 5, wherein an external surface of the foldable cover is made of leather materials and the internal surface thereof is made of flexible materials.

16. The protection case, as recited in claim 6, wherein an external surface of the foldable cover is made of leather materials and the internal surface thereof is made of flexible materials.

17. The protection case, as recited in claim 7, wherein an external surface of the foldable cover is made of leather materials and the internal surface thereof is made of flexible materials.

18. The protection case, as recited in claim 8, wherein an external surface of the foldable cover is made of leather materials and the internal surface thereof is made of flexible materials.

19. The protection case, as recited in claim 9, wherein an external surface of the foldable cover is made of leather materials and the internal surface thereof is made of flexible materials.

20. The protection case, as recited in claim 10, wherein an external surface of the foldable cover is made of leather materials and the internal surface thereof is made of flexible materials.
